(19) United States
(12) Patent Application Publication
(10) Pub. No.: US 2025/0079633 A1
(43) Pub. Date: Mar. 6, 2025

(54) METHOD OF MAKING A CERAMIC-COATED POLYETHYLENE SEPARATOR FOR LITHIUM-METAL BATTERIES

(71) Applicant: United Arab Emirates University, Al Ain (AE)

(72) Inventors: SAMBASIVAM SANGARAJU, Al Ain (AE); RAVI MUCHAKAYALA, Hyderabad (IN); FEN RAN

(21) Appl. No.: 18/238,698

(22) Filed: Aug. 28, 2023

(51) Int. Cl. H01M 50/451; H01M 50/403; H01M 50/417; H01M 50/434

(52) U.S. Cl. CPC H01M 50/451; H01M 50/403; H01M 50/417; H01M 50/434

(57) ABSTRACT

The method of making a ceramic-coated polyethylene separator for lithium-metal batteries is a method of making a lithium lanthanum titanate (Li_{0.29}La_{0.57}TiO₃) (LLTO) defect Perovskite particle coating for polyethylene separators. LLTO, disodium laurethsulfosuccinate (DLSS) solution, sodium carboxymethyl cellulose (CMC), and deionized (DI) water are mixed to form a coating mixture. The coating solution may include a ratio of LLTO:DLSS solution:CMC:DI water of approximately 38.9:1:0.1:60 by weight. The coating mixture is then coated on a single side of a polyethylene separator substrate to form a single-sided, ceramic-coated polyethylene separator. Coating may be performed using a doctor blade or the like. The ceramic-coated polyethylene separator is then dried at approximately 70° C. for approximately 10 minutes in a drying oven or the like. Additional drying may be performed in a vacuum oven at 60° C. to remove any residual solvents.

### BACKGROUND

### Field

The disclosure of the present patent application relates to the manufacture of rechargeable batteries, and particularly to a method of making a lithium lanthanum titanate (LLTO) ceramic-coated polyethylene separator for lithium-metal batteries.

### Description of Related Art

During the operation of lithium-metal batteries, the lithium (Li) ions repeatedly transport between the cathode and anode through the electrolytes and separators. The anisotropic distribution and repeated deposition of Li ions on the lithium anode surface results in heterogeneous nucleation and lithium dendrite growth, resulting in degradation of the battery cycle life and also creating safety problems.

Apart from lithium-metal components, lithium-metal batteries (LMBs) include positive electrodes, separators and an electrolyte. The separator is an important part of the LMB, serving to 1) prevent contact between the positive and negative electrodes, 2) provide microporous channels for the transport of Li⁺ ions, 3) store electrolytes and prevent them from decomposing, and 4) prevent the diffusion of byproducts, such as lithium dendrites, from redox reactions of the positive and negative electrode material. Traditional polyolefin microporous membranes, such as polyethylene (PE) and polypropylene (PP), most commonly serve as separators in LMBs. However, these separators undergo severe thermal shrinkage at higher temperatures. This problem can be fatal to the safety of the battery because it may cause an internal short circuit, eventually leading to fire or even explosion. Additionally, the poor wettability and low porosity of these separators seriously affects the conductivity of the lithium ions, thus affecting overall performance of the batteries. These problems inherent in polyolefin-based separators have become the key obstacles to the development of safe, high-power batteries.

In view of the above, there has been a great deal of research in modifying present, commercially available PE separators. The methods of modification mainly include blending modifications, composite modifications, coating modifications, and ionic liquid modifications. Surface coating is one of the most important and commonly used methods. The surface of the polyolefin membrane is usually coated with ceramics, such as Al₂O₃, SiO₂, or TiO₂.

The Al₂O₃ ceramic coated separator (CCS) has been shown to have promise for addressing the wettability and dimensional stability of commercial separators. Most of these CCSs are fabricated using a coating mixture of hydrophilic inorganic powders and a small amount of polymeric binders dispersed in organic solvents. However, these CCSs fail to meet some of the requirements for lithium batteries because of their low adhesive nature (resulting in coating layers scratched off from the separators), non-uniform coatings, and electrochemical degradation. One of the largest issues with CCSs is that they are not a source of lithium ions themselves. It would be advantageous to be able to coat a PE separator substrate with a ceramic, similar to CCS separators, with the ceramic being also a source of lithium ions while providing the advantages associated with CCSs. Thus, a method of making a ceramic-coated polyethylene separator for lithium-metal batteries solving the aforementioned problems is desired.

### SUMMARY

The disclosed method of making a ceramic-coated polyethylene separator for lithium-metal batteries is a method of making a lithium lanthanum titanate (Li_{0.29}La_{0.57}TiO₃) (LLTO) defect Perovskite particle coating for polyethylene separators. LLTO, disodium laurethsulfosuccinate (DLSS) solution, sodium carboxymethyl cellulose (CMC), and deionized (DI) water are mixed to form a coating mixture. The DLSS solution may be a 28 wt % aqueous solution. The coating solution may include a ratio of LLTO:DLSS solution:CMC:DI water of approximately 38.9:1:0.1:60 by weight. Mixing of the coating mixture may be performed using a centrifugal mixer at approximately 1000 rpm for approximately 12 minutes.

The coating mixture is then coated on a single side of a polyethylene separator substrate to form a single-sided, ceramic-coated polyethylene separator. Coating may be performed using a doctor blade or the like. The ceramic-coated polyethylene separator is then dried at approximately 70° C. for approximately 10 minutes in a drying oven or the like. Additional drying may be performed in a vacuum oven at 60° C. to remove any residual solvents. The coating volume and thickness may be selected such that, following drying, the thickness of the ceramic layer coated on the polyethylene separator is 7 μm.

These and other features of the present subject matter will become readily apparent upon further review of the following specification.

### BRIEF DESCRIPTION OF DRAWINGS

FIG. 1 is a graph showing a comparison of ionic conductivity, electrolyte uptake and Gurley number for polyethylene separators coated with aluminum oxide (Al₂O₃) (CCS), bare polyethylene (PE) separators, and LLTO Perovskite-coated polyethylene separators (GCSs) prepared by the disclosed method of making a ceramic-coated polyethylene separator for lithium-metal batteries.

FIG. 2A is a graph showing a comparison of initial charge-discharge curves for CCS, bare PE, and GCS separator samples.

FIG. 2B is a graph showing a comparison of electrochemical impedance spectroscopy (EIS) results for CCS, bare PE, and GCS separator samples.

FIG. 2C is a graph showing a comparison of rate capability results for CCS, bare PE, and GCS separator samples.

FIG. 2D is a graph showing a comparison of cycle performance curves for CCS, bare PE, and GCS separator samples.

FIG. 3A is a scanning electron microscope (SEM) image of a CCS separator sample.

FIG. 3B is an SEM image of a GCS separator sample.

FIG. 3C is an SEM image of a cross-section of the CCS separator sample of FIG. 3A.

FIG. 3D an SEM image of a cross-section of the GCS separator sample of FIG. 3B.

Similar reference characters denote corresponding features consistently throughout the attached drawings.

### DETAILED DESCRIPTION

The method of making a ceramic-coated polyethylene separator for lithium-metal batteries is a method of making a lithium lanthanum titanate (Li_{0.29}La_{0.57}TiO₃) (LLTO) defect Perovskite particle coating for polyethylene separators. LLTO, disodium laurethsulfosuccinate (DLSS) solution, sodium carboxymethyl cellulose (CMC), and deionized (DI) water are mixed to form a coating mixture. The DLSS solution may be a 28 wt % aqueous solution. The coating solution may include a ratio of LLTO:DLSS solution:CMC:DI water of approximately 38.9:1:0.1:60 by weight. Mixing of the coating mixture may be performed using a centrifugal mixer at approximately 1000 rpm for approximately 12 minutes. The above parameters are a non-limiting example of the various components and steps of the presently disclosed method. Other aspects of these parameters are also contemplated within the scope of the present subject matter.

The coating mixture is then coated on a single side of a polyethylene separator substrate to form a single-sided, ceramic-coated polyethylene separator. Coating may be performed using a doctor blade or the like. The ceramic-coated polyethylene separator is then dried at approximately 70° C. for approximately 10 minutes in a drying oven or the like. Additional drying may be performed in a vacuum oven at 60° C. to remove any residual solvents. The coating volume and thickness may be selected such that, following drying, the thickness of the ceramic layer coated on the polyethylene separator is 7 μm.

For purposes of comparison, LLTO Perovskite-coated polyethylene separators (GCSs) were prepared as described above, as well as polyethylene separators coated with aluminum oxide (Al₂O₃), which were prepared in the same manner but with an equivalent weight of aluminum oxide substituted for the LLTO. These aluminum oxide samples are herein referred to as “CCS” samples. The GCS and CCS samples were also compared against plain, or “bare”, polyethylene (PE) separators. The bare PE, CCS, and GCS surface morphologies were investigated by field-emission scanning electron microscope. The contact angles were measured by a static contact angle analyzer using the same quantity of 1.15 M LiPF₆ (EC:EMC, 3:7, V/V) liquid electrolyte and water. The air permeability of the separator samples, expressed by the Gurley number, was evaluated using a densitometer according to the JIS P8117 standard (Japanese Industrial Standards). The Gurley number was determined by measuring the time(s) for 100 mL of air to pass through a specific area of the separator sample under constant air pressure (6.52 psi). The electrolyte wettability of the bare PE, CCS, and GCS samples was measured by the electrolyte drop test. The thermal stability and the liquid electrolyte uptake of all separator samples were determined by the common method. The ionic conductivity and the lithium ion transport number of the samples were measured using an AC impedance analyzer.

Coin cells (2032) were used to evaluate the electrochemical performance of the coated separator samples. The lithium ion manganese oxide (LMO) cathode was prepared by a slurry casting method. Particularly, a slurry was prepared by mixing LMO powder (95 wt %), conductive carbon (Super P, 5 wt %), polyvinylidene fluoride binder (PVDF, 5 wt %), and N-methyl-2-pyrrolidone (NMP) as a dispersing agent. The slurry was then cast onto the aluminum current collector (15 μm, Sam-A aluminum) using a doctor blade instrument and dried in an oven at 130° C. for one hour. After complete drying, the electrodes were roll-pressed using a roll-pressing machine to control the thickness (52 μm) and then punched into round discs (10 mm diameter, loading level=10.0 mg·cm⁻² and density=2.7 g·cm⁻³). These electrode discs were dried at 60° C. for 12 hours under vacuum and transferred into a glove box for cell assembly.

The coin-type half cells (LMO/Li) were assembled in an argon-filled glove box with 100 μL electrolyte (1.15 M lithium hexafluorophosphate (LiPF₆) in ethylene carbonate/ethyl methyl carbonate (EC/EMC=3/7, V/V)). Following the coin cell assembly and aging, the pre-cycling was performed in two stages: cell formation (1 cycle) under a constant current (CC) mode for both charging and discharging processes at C/10 (0.150 mA·cm⁻²) and then cell stabilization (3 cycles) with charging under a constant current/constant voltage (CC/CV) mode and discharging under a CC mode at C/5 (0.300 mA·cm⁻²) using a charge/discharge cycle tester at 25° C. The rate capabilities were performed by charging at a constant C-rate (C/2) in the CC/CV mode and discharging at different C-rates ranging from C/2 to 20 C in the CC mode. Finally, cycling was performed at C/2 (charging in CC/CV mode) and 1C (discharging in CC mode) for 500 cycles at 25° C. The potential range was 3.0-4.3 V.

The wettability of the bare PE, CCS and GCS samples was directly identified using the water contact angle (WCA) measurement. The WCAs obtained were 95.4°, 32.0°, and 8.1° for the bare PE separator, CCS, and GCS samples, respectively. The wettability was found to be greater for the present ceramic-coated polyethylene separator (GCS) than the CCS or bare PE separator samples. The bare PE separator showed the greatest WCA because of its inherent hydrophobic nature. However, the addition of the ceramics rendered the separators more hydrophilic compared to the bare PE sample because of the hydrophilic nature of the Al₂O₃ and LLTO coatings.

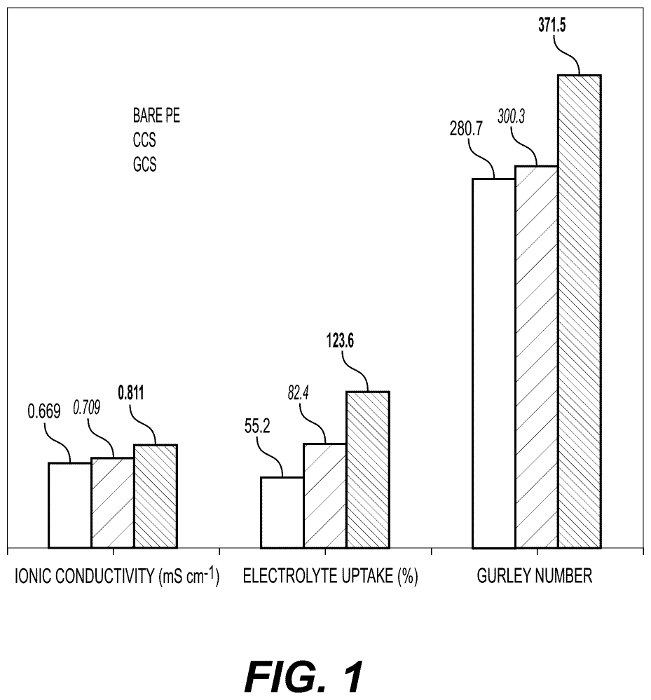

FIG. 1 shows a comparison of the electrolyte uptake by the GCS, CCS and bare PE samples. As shown in FIG. 1, the GCS sample showed greater electrolyte uptake compared to the CCS and bare PE separator samples, which corroborates the WCA results. Compared with the bare PE and CCS samples, the GCS sample absorbed more Li ions in the electrolyte and retained more in its pores. The separator's wettability and liquid fluid uptake play a vital role in Li battery performance. High wettability and liquid uptake can enhance ion transport between the electrodes, resulting in improved high-rate battery performance.

The thermal properties of the bare PS, GCS and CCS separator samples were determined by performing thermal shrinkage at 130° C. for 30 minutes in an oven. The bare PE separator sample exhibited a significant degree of thermal shrinkage of the original size (16.3%), while the CCS and GCS samples each maintained 98.4% of their original sizes. Excellent thermal stability is essential for preventing thermal runaway, thereby increasing the safety of batteries at elevated temperatures. The GCS sample exhibits good thermal stability which is almost equal to, or higher than, that of the Al₂O₃-coated separator.

The interconnection between the bare PE separator and the coated CCS and GCS separators was confirmed by measuring the Gurley number, as shown in FIG. 1. The observed Gurley number of the GCS separator sample is significantly high (<90.8 s·mL⁻¹) compared with the bare PE and CCS samples. This is due to the increased interaction of the LLTO particles/3D conductive structures. Based on physical properties (i.e., the Gurley number, wettability, electrolyte uptake, and thermal stability), it can be concluded that defect Perovskite LLTO is a good coating material for developing high performance coated separators for high temperature battery applications.

As shown in FIG. 1, the bare PE separators inherently do not show ionic conductivity, and only display ionic conductivity when soaked with an electrolyte. Both the GCS and CCS samples showed higher ionic conductivity values than the bare PE separator, which may be due to more mobile ions entrapped within the coated separator. The ionic conductivities of the separator samples were calculated as σ=nᵢμᵢqᵢ, where qᵢ is the charge of mobile ions, μᵢ is the mobility of the ions, and nᵢ is the number of mobile ions. From FIG. 1, it is clear that the GCS sample has a higher ionic conductivity (0.811 mS·cm⁻¹) than the bare PE and CCS samples (0.669 mS·cm⁻¹ and 0.811 mS·cm⁻¹, respectively), which may be due to higher μᵢ and nᵢ values in the GCS sample than in the CCS and bare PE separator samples.

With regard to ionic conductivity in the samples, ions move unidirectionally through the PE separator, whereas the movement of ions in ceramic coatings depends on the choice of material. Thus, ion mobility in coated separators can be divided into two parts: 1) movement within the PE matrix, and 2) movement within the coating matrix. The movement within the PE matrix is the same for all the separators, but the difference lies in the movement within the coating matrix. The charge of conducting ions (qᵢ) is the same for all separators because the electrolyte used is common, thus the same ions (Li⁺) are considered. For the coated separators, although the Al₂O₃ is porous, its ionic conductivity is lower than that of LLTO because the LLTO inherently has Li⁺ ions (thus, there are more charge carriers (nᵢ) compared to Al₂O₃ (nᵢ in GCS>CCS)), and also the LLTO defect Perovskite is a lithium conductor because of the Li⁺ transport channels, thus leading to an enhancement of the Li⁺ conduction capability (μᵢ) compared to Al₂O₃ (μᵢ in GCS>CCS).

The Li⁺ ion transference numbers are measured by using Li symmetric cells (Li-coated separator-electrolyte-Li) and applying chronoamperometry and electrochemical impedance spectroscopy. The calculated Li ion transference number of the GCS sample is 0.76, which is greater than that of the CCS and bare PE separator samples (0.62 and 0.34, respectively). This could be due to 1) the Li⁺ ions already in LLTO matrix, which increases the number of the total lithium ions per volume ratio which, as a result, increases the lithium ion transference number, 2) the better wettability of LLTO compared to other separators shows that there is better adsorption of the ions onto the LLTO surface which, in turn, enhances the dissociation of the salt, thereby promoting a large number of free Li⁺ ions, 3) LLTO is a better Li⁺ ion conductor than the other separators because of the abundant 3D Li⁺ ion conduction channels, thus the mobility of Li⁺ ions in the LLTO is higher, and/or 5) the Li⁺ ion transference behavior is also affected by the affinity and pore structure of the separator.

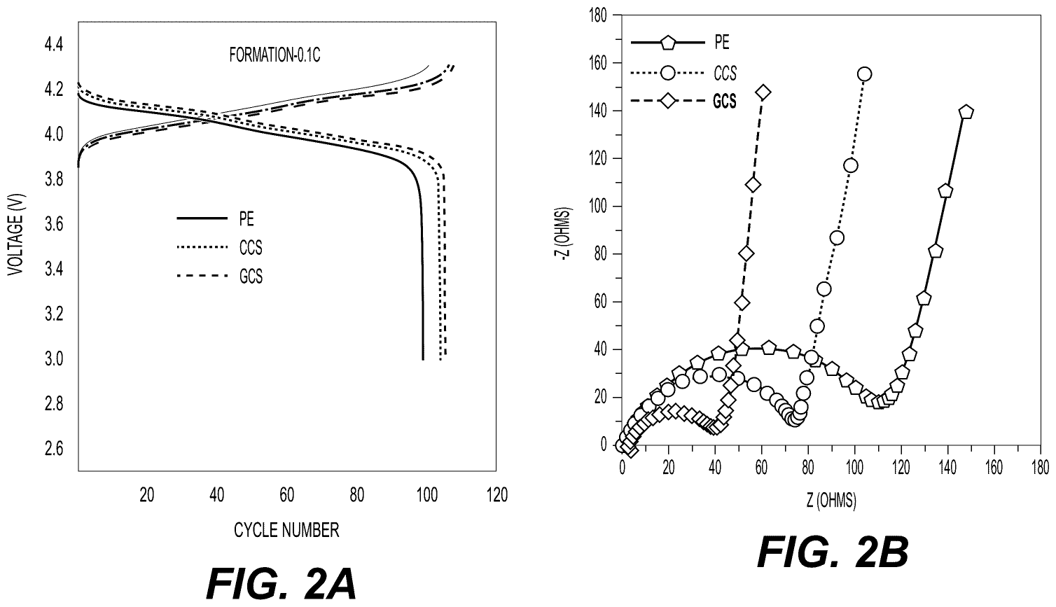

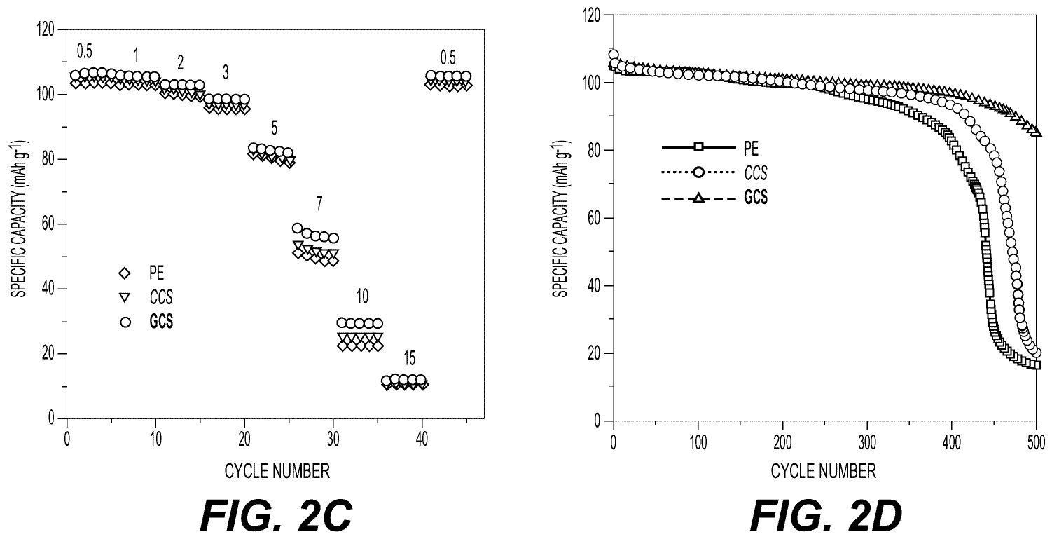

Li-LMO coin-type cells were used to investigate the electrochemical performance when the different separator samples were used in the potential range of 3.0-4.2 V. The charge-discharge curves for the cell formation with bare PE and coated separators (CCS and GCS) are shown in FIG. 2A which, as shown, display a similar shape but slightly different specific capacities; i.e., the cells with GCS separators had a discharge capacity ˜105.4 mAh·g⁻¹ and CE˜99.8%, whereas the bare PE and CCS samples had a discharge capacity of 100.4 mAh·g⁻¹ and ˜104.2 mAh·g⁻¹, respectively, and a CE of ˜96.7% and ˜99.7% at 0.1 C, respectively.

As shown in FIG. 2B, cells with the GCS separator had lower interfacial cell resistance (Rᵢₙₜ) than those with the CCS separator. Generally, the impedance spectra of the Li batteries consist of two partially overlapped semicircles and a straight sloping line at the low frequency. The high-frequency semicircle is due to Li-ion migration through the solid electrolyte interphase, thus a solid electrolyte interface resistance (R_{SEI}). The mid-frequency semicircle is due to the charge transfer between the electrodes and the Li⁺ ions, thus a charge transfer resistance (R_{ct}). Therefore, the cell interfacial resistance (Rᵢₙₜ) is represented by the summation of these two resistances: Rᵢₙₜ=R_{SEI}+R_{ct}.

A reduction in the R_{ct} will result in a reduction in Rᵢₙₜ since they vary directly. The cells with the GCS displayed lower resistance due to the reduction in the R_{ct} caused by the higher ionic conductivity and Li transference number compared to the other separators. Thus, the GCS separator is suitable for high-rate capability cycle performance of the cells, since they are also affected by the Rᵢₙₜ.

The results of the rate capability tests of cells with separator samples are shown in FIG. 2C. The discharge capacities of cells with GCS, CCS and bare PE are 105.74 mA·h·g⁻¹, 105.54 mA·h·g⁻¹, and 104.64 mA·h·g⁻¹ at C/2, respectively. However, the difference in the discharge capacities between cells with the GCS and CCS is marginal at lower C-rates, whereas a noticeable difference is observed at higher C-rates. The higher discharge capacity of cells with GCS separators at higher C-rates may be due to the high ionic conductivity, high Li⁺ transference number, and low interfacial resistance.

The cycle performance of the coin cells with coated separators (LMO/coated separator/Li) was investigated up to 500 cycles. As shown in FIG. 2D, the cells with the GCS separator exhibited a higher discharge capacity and cycling performance than those with the CCS separators. After 500 cycles, cells with the GCS separator had an initial capacity retention of 80% (84.5 mA·h·g⁻¹), whereas cells with the CCS separator had an initial capacity retention of 19% (20.0 mA·h·g⁻¹). The low cycle performance of CCS and bare PE separators are due to Li dendrite growth on the Li metal surface. Therefore, the observed higher cycle stability of GCS cells is due to the suppression of dendrite formation by the LLTO coating layer.

In Li-metal batteries, the Li metal anode is plated and stripped of Li. During plating, the Li⁺ ions migrate to the surface of the Li metal where there is less resistance or greater current distribution, resulting in more Li⁺ reduced on a single position (i.e., nucleation), leading to dendrite growth. With repeated cycling, these dendrites can break off from the surface of the anode, leading to the formation of dead lithium. This causes a repeated decomposition of the electrolyte components, resulting in a low CE. To curb this problem, an even distribution of Li⁺ ions across the surface of the Li metal anode during plating will suppress dendrite formation, ultimately improving the cycle performance and CE. It is postulated that the 3D ionic conduction channels in the LLTO matrix help in the distribution of Li-ions by regulating the path taken as they permeate through the separator, leading to homogeneous deposition on the Li metal surface during repeated cycling. As a result, the process of dendrite formation is suppressed. Therefore, the observed higher cycle stability and CE of the GCS cells can also be attributed to the suppression of dendrite formation by the LLTO coating layer, which is further confirmed with ex situ scanning electron microscope (SEM) analysis.

It is well-known that the morphology of the Li-metal anode is of vital importance in lithium-metal batteries, and it undergoes a transformation during cycling. To understand the morphology changes and Li-ion redistributor behavior when ceramic-coated separators are used to build lithium metal batteries, SEM analysis was performed on the lithium metal surface across the coating layer side after 50 cycles in LMO/Li cells.

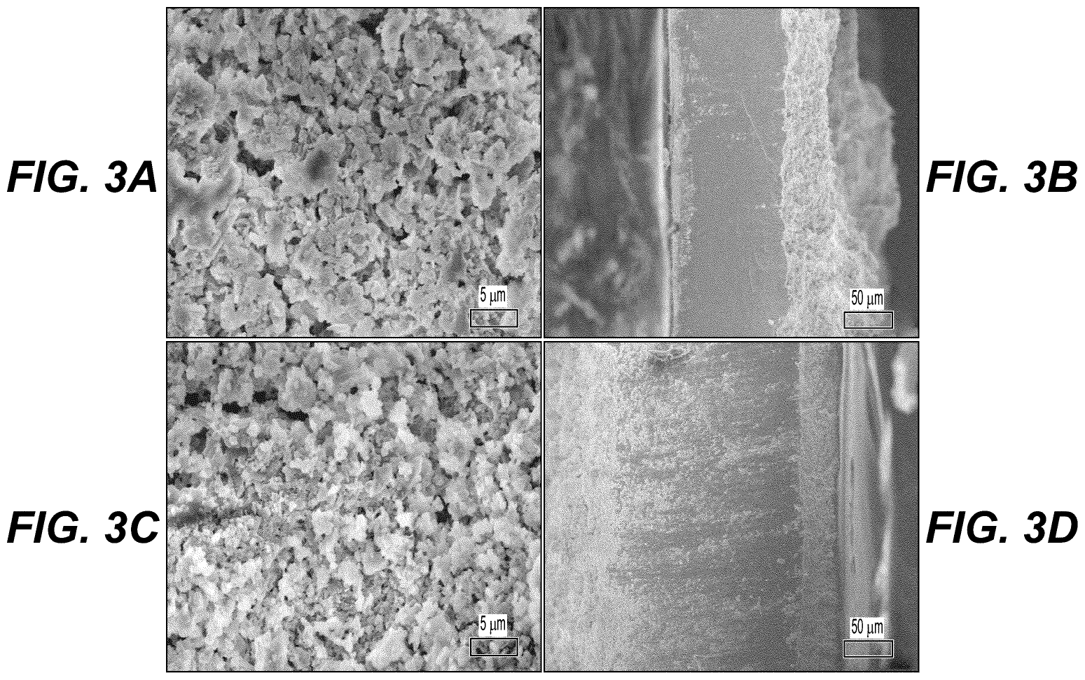

As shown in FIG. 3A, large, flower-like, sharp Li dendrites are observed with the CCS sample, which is in contrast with the dense, flat and rounded shaped dendrites seen in the GCS cell (shown in FIG. 3B). Further, in the cross-sectional images of FIGS. 3C and 3D, respectively, it can be seen that the dendrite layer thickness of GCS is less than that of the CCS, which is due to the dendrite-inhibiting nature of LLTO. From the SEM analysis, it is confirmed that the LLTO coating layer works as a redistributor of lithium-ion and as a dendrite inhibiter.

It is to be understood that the method of making a ceramic-coated polyethylene separator for lithium-metal batteries is not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

1. A method of making a ceramic-coated polyethylene separator for lithium-metal batteries, comprising the steps of:
mixing lithium lanthanum titanate, disodium laurethsulfosuccinate solution, sodium carboxymethyl cellulose, and deionized water to form a coating mixture;
coating a single side of a polyethylene separator substrate with the coating mixture to form the ceramic-coated polyethylene separator; and
drying the ceramic-coated polyethylene separator.

2. The method of making a ceramic-coated polyethylene separator for lithium-metal batteries as recited in claim 1, wherein the step of mixing the lithium lanthanum titanate, the disodium laurethsulfosuccinate solution, the sodium carboxymethyl cellulose, and the deionized water comprises mixing the lithium lanthanum titanate, the disodium laurethsulfosuccinate solution, the sodium carboxymethyl cellulose, and the deionized water at a ratio of 38.9:1:0.1:60 by weight.

3. The method of making a ceramic-coated polyethylene separator for lithium-metal batteries as recited in claim 1, wherein the step of mixing the lithium lanthanum titanate, the disodium laurethsulfosuccinate solution, the sodium carboxymethyl cellulose, and the deionized water comprises mixing the lithium lanthanum titanate, the disodium laurethsulfosuccinate solution, the sodium carboxymethyl cellulose, and the deionized water at a mixing rate of 1000 rpm.

4. The method of making a ceramic-coated polyethylene separator for lithium-metal batteries as recited in claim 3, wherein the step of mixing the lithium lanthanum titanate, the disodium laurethsulfosuccinate solution, the sodium carboxymethyl cellulose, and the deionized water comprises mixing the lithium lanthanum titanate, the disodium laurethsulfosuccinate solution, the sodium carboxymethyl cellulose, and the deionized water for 12 minutes.

5. The method of making a ceramic-coated polyethylene separator for lithium-metal batteries as recited in claim 1, wherein the step of coating the single side of the polyethylene separator substrate with the coating mixture is performed using a doctor blade.

6. The method of making a ceramic-coated polyethylene separator for lithium-metal batteries as recited in claim 1, wherein the step of drying the ceramic-coated polyethylene separator comprises drying the ceramic-coated polyethylene separator at 70° C. for 10 minutes.

7. The method of making a ceramic-coated polyethylene separator for lithium-metal batteries as recited in claim 6, wherein the step of drying the ceramic-coated polyethylene separator further comprises additional drying of the ceramic-coated polyethylene separator in a vacuum oven at 60° C.

8. The method of making a ceramic-coated polyethylene separator for lithium-metal batteries as recited in claim 1, wherein, following the step of drying the ceramic-coated polyethylene separator, a thickness of a ceramic layer coated on the polyethylene separator is 7 μm.

9. A ceramic-coated polyethylene separator for lithium-metal batteries made according to the method of claim 1.
